(19) United States
(12) Patent Application Publication
(10) Pub. No.: US 2026/0364872 A1
(43) Pub. Date: Nov. 19, 2026

(54) CALIBRATION TUBE FOR PIPE REPAIR APPLICATIONS

(71) Applicant: BONDYA GMBH, Zunzgen (CH)

(72) Inventor: Daniel BOLLER, Wittnau (CH)

(21) Appl. No.: 19/478,330

(22) PCT Filed: Apr. 24, 2024
(86) PCT No.: PCT/EP2024/061269

§ 371 Date: Oct. 24, 2025

(30) Foreign Application Priority Data
Apr. 24, 2023 (EP) 23169590.9

(51) Int. Cl. B29C 63/34; B29C 63/00; B29C 73/10; B29L 23/00

(52) U.S. Cl. CPC B29C 63/341; B29C 63/0069; B29C 73/10; B29L 2023/22

(57) ABSTRACT

The present invention relates to textile hoses made of a fabric in which the fabric has a maximum tensile force according to DIN 53857 of more than 2200 N and an air permeability of less than 10 l/(dm²×min), and in which the fabric is sewn over the entire length of the hose via overlapping edges of the fabric with at least one seam. On the outer side of the seam, a plastic web is applied to the disclosed hose, which extends over the seam area of the hose, so that the outside is mostly smooth and the stability of the construction is improved. The present invention further relates to the use of such textile hoses for sealing defective pipes, kits for rehabilitating pipes comprising such textile hoses, and processes for rehabilitating and/or repairing pipes using such textile hoses or kits.

The present invention relates to textile hoses made of a fabric in which the fabric has a maximum tensile force according to DIN 53857 of more than 2200 N and an air permeability of less than 10 l/dm²×min, and in which the fabric is sewn over the entire length of the hose via overlapping edges of the fabric with at least one seam. On the outward-facing side of the seam, a plastic web is applied to the disclosed hose, which extends over the seam area of the hose. The present invention further relates to the use of such textile hoses for sealing defective pipes, kits for rehabilitating pipes comprising such textile hoses, and processes for rehabilitating and/or repairing pipes using such textile hoses or kits.

### PRIOR ART

Rehabilitating or replacing defective underground water or wastewater pipes is a very costly and time-consuming process. If work has to be carried out on pipes laid under roadways, this is inevitably associated with a significant disruption to the traffic running above. In addition, pipes may no longer be accessible from above due to a superstructure. A new construction on a different route would be very costly here.

In order to be able to repair pipes that are defective or otherwise in need of rehabilitation, a process has been developed that avoids having to replace the pipes by sealing a defective inner pipe wall by pulling in and applying a lining, such as a hose, to the inner pipe wall. A slight loss of cross-section is accepted.

EP 3 137 804 B1 describes a lining for the rehabilitation of partially defective pipes for drinking water or wastewater with such a lining. The knitted hose material used here has neither radial nor axial strength, and therefore lies against the inner wall of a usually defective pipe during installation, wherein bulges are also copied, for example. During rehabilitation, this can lead to the formation of new blockages and cavities, which in turn have the disadvantage of creating new leakage and blockage sources in the pipe.

In a conventional process of rehabilitating a wastewater pipe, a felt hose is inserted using the so-called inversion process. In this process, a slideway or a foil hose (“preliner”) is first pulled into the pipe to be rehabilitated as a so-called lost formwork, and then a felt hose (“main liner”) is pulled in as a carrier hose, together with a calibration hose. However, neither the preliner nor the main liner can absorb radial or axial forces due to their material properties (unreinforced plastic film and felt fabric). The combination of main liner and calibration hose is limited in its ability to absorb axial forces. The conventional preliner is impermeable to air due to its material structure. All components are installed one after the other using the inversion process. In this case, the installation is carried out from maintenance manhole to maintenance manhole or from a maintenance manhole to a “blind” end (i.e., installation in a pipe end without access, so-called open-end process). After installation, the system is pressurized to around 0.8 bar and expanded. The synthetic resin contained in the main liner is then cured. This system also has the disadvantage that the defective contour of the inner wall of the pipe to be rehabilitated is copied, with the negative consequences described above. As the system can hardly absorb any axial forces, irregular cross-sections of the old pipe are imitated. The felt hose follows the shape of the old pipe with all its deformations.

In another well-known process, the so-called hybrid liner process, a hybrid liner, i.e., a felt hose reinforced with glass fiber mats, is utilized. The hybrid liner is drawn into a reinforced, light- and air-impermeable foil hose (preliner) and drawn into the defective pipe along with the calibration hose. The hybrid liner is supplied or impregnated with synthetic resin on-site at the construction area. The assembly is pulled in from manhole to manhole and expanded radially using the calibration hose. The synthetic resin contained in the hybrid liner is then cured.

After curing, the hybrid liner has a much higher resistance than a simple felt hose due to the integrated glass fiber reinforcement with a higher modulus of elasticity and higher flexural strength. However, due to the rigidity of the integrated glass fiber mats, the inverting process is not possible here. The hybrid liner can only be installed by pulling it into a pipe without kinking and can only be bent to a very limited extent due to the limited bendability of the glass fibers. This makes its installation, which is only possible between freely accessible maintenance manholes, more complex and more costly. It is an object of the invention to propose an assembly and a process with which the disadvantages known from the prior art are avoided or at least greatly reduced.

WO 2020/244883 A1 describes a system for rehabilitating a pipe with a fabric layer resting on the inner wall of the pipe, a felt layer positioned underneath, and an inner fabric layer coated with a release agent, in particular in the form of silicone. In the system described in WO 2020/244883 A1, the fabric layers are formed by textile hoses that are woven in one piece (one piece woven) and thus have no seams or welded seams that could form potential weak points in the hoses. Unfortunately, one disadvantage of this system is that the available hoses based on this technology do not have sufficient tear resistance, which means that the hoses can be damaged during the rehabilitation of a pipe, impairing the rehabilitation result. Another disadvantage is that the hoses are produced using special machines and not in large tubular webs, which makes the hoses relatively expensive.

Against this background, there is a need for a pipe rehabilitation system that can be produced cost-effectively on the one hand and is sufficiently tear-resistant and resilient on the other, so that no defects, damage, or holes occur when the system is used to rehabilitate pipes.

The present invention addresses this need.

### DESCRIPTION OF THE INVENTION

In the investigations on which this invention is based, it was surprisingly found that hoses with sufficient stability can be manufactured from fabric commonly referred to as “airbag fabric”, which is characterized by an air permeability of less than 10 l/(dm²×min) (determined in accordance with DIN EN ISO 9237:1995, at a test pressure of 500 Pa) and a maximum tensile force of at least 2200 N/5 cm. In other words, the fabric is suitably designed such that it provides the specified air permeability and maximum tensile force on its own, without the need for a coating. For the production of textile hoses from such a fabric, the opposite edges of webs of the fabric can be attached to each other with a seam. A plastic web is then applied to this seam, which on the one hand distributes tensile forces on the seam over a large area of the hose, and on the other hand covers protruding parts of the seam and protects them from damage caused by friction with other components of the repair system. This construction process is particularly advantageous for “calibration hoses”, which are used as the innermost component of the repair system and are removed from the pipe again after a synthetic resin has solidified.

According to a first aspect, the present invention thus relates to a textile hose made of a fabric with a maximum tensile force in accordance with DIN 53857 of at least 2200 N/5 cm and an air permeability of less than 10 l/(dm²×min), wherein the fabric is connected over the entire length of the textile hose by at least one seam via overlapping edges of the fabric and a plastic web which extends over the seam area of the hose, is attached to the outer side of the seam.

To give the tubular construction a particularly advantageous durability, it is suitable if the overlapping edges of the fabric are joined with at least two seams, wherein three seams have proven to be an optimum compromise between processing effort and strength; such a design is therefore particularly preferred.

If the hose has several seams, these are preferably placed at a distance from each other that is large enough so that the stability of the fabric is not affected by the seams, and that on the other hand there is no overlapping of the overlapping edges of the fabric beyond the required extent, which would lead to high material costs. For these reasons, it is preferable if the multiple seams are positioned at a distance in the range of 0.1 to 1 cm from each other, and more preferably 0.2 to 0.6 cm.

With regard to the material from which the fabric is formed, the present invention is not subject to any relevant limitations, with the proviso that the material has a maximum tensile force in accordance with DIN 53857 of at least 2200 N/5 cm. The specification “5 cm” indicates that the maximum tensile force is determined for a belt with a width of 5 cm.

The requirement for a maximum tensile force in the specified range is fulfilled if this maximum tensile force is achieved either in the warp direction or in the weft direction of the fabric. For the hose according to the invention, it is preferable if this maximum tensile force is provided by the direction that is arranged in the hose in the circumferential direction.

Materials from which fabrics with the required properties can be produced and which are commercially available are, for example, polyamide or PET (=polyethylene terephthalate) fabrics, so that such fabrics are preferred for manufacturing the hoses according to the invention. Particularly preferred are polyamide fabrics, and particularly polyamide fabrics based on polyamide 6, polyamide 6.6, or polyamide 4.6.

With regard to the fineness of the yarns used for the fabrics, the present invention is not subject to any relevant limitations, with the proviso that the fineness must be able to provide the required strength on the one hand and that no more material than necessary should be used on the other. A range of 200 to 700 dtex and, in particular, 230 to 500 dtex can be specified as suitable orders of magnitude for the fineness of the weft and warp threads. The areal weight of the fabric-which is to a certain extent dependent on the fineness—can preferably be adjusted in the range of 120 to 400 g/m² and particularly in the range of 140 to 320 g/m² for the fabric from which the textile hose is formed.

In order to prevent adhesion of synthetic resin when using the textile hoses indicated in a pipe rehabilitation system as described above, it is suitable if the outside of the textile hose according to the invention is modified with an adhesion-suppressing coating. For this purpose, a silicone coating is particularly suitable. The “outside” of the hose refers to the side on which the plastic web is attached.

As mentioned, the fabric from which the textile hose according to the invention is formed exhibits a maximum tensile force in accordance with DIN 53857 of at least 2200N/5 cm. More preferably, the maximum tensile force is at least 2500 N/5 cm and particularly at least 2700 N/5 cm, and/or at most 6000 N/5 cm, in particular at most 5000 N/5 cm, and even more preferably at most 4500 N/5 cm. Further advantageous properties for the fabric are the tear propagation resistance and the elongation at maximum tensile force. With regard to the elongation at maximum tensile force, it is preferable that the value is more than 15% and/or at most 70%. Even more preferably, the elongation at maximum tensile force is at least 20% and particularly at least 25%, and/or at most 60% and particularly at most 50%. For the tear propagation resistance, a range of 80 to 300 N and, in particular, 100 to 250 N may be considered as suitable. The elongation at maximum tensile force and the tear propagation resistance are to be determined in accordance with DIN 53857 and DIN 53859, respectively, wherein the versions of the standards valid on the filing date shall apply for all standards specified here. Furthermore, the fabric, or the polymer from which the fabric is formed, preferably has a melting point of at least 120 °C and preferably of at least 150 °C.

The plastic web is suitably formed from a material that is sufficiently resistant to a synthetic resin used for a pipe rehabilitation system and is as unreactive as possible towards it. Suitable materials particularly include polyolefins, polysilicone, or polyurethane. Suitable polyolefins are, for example, polyethylene or polypropylene. Polysilicone or polyurethane are particularly suitable, as these materials either already have release agent properties per se or are particularly temperature-resistant, so that they cannot be damaged by the effects of heat when a synthetic resin hardens.

The plastic web has a width that ensures that existing seams in the hose are covered by the plastic web and that there is a certain overhang so that the plastic web can be securely fastened to the textile hose at its edges. Preferably, the plastic web extends over a width of 0.5 to 3 cm and preferably 1 to 2 cm over the seam or seams with which the edges of the hose are connected.

The plastic web has a thickness that gives the layer the necessary durability. As a favorable range for the thickness, a scope in the range of 0.1 to 1.5 mm and preferably 0.2 to 0.8 mm can be specified.

The plastic web can be attached to the outside of the textile hose according to the invention with a bonding agent, such as an adhesive, or can be applied directly to the outside, for example by melting or otherwise softening an outer side of the plastic web and laminating it to the hose.

The textile hose according to the invention preferably has a diameter adapted to conventionally installed pipes. Since repair systems based on the technology described can be reliably used with smaller pipe diameters due to the greater curvature, it is preferred that the textile hose has a diameter in the range of 5 to 30 cm, and preferably 8 to 20 cm.

With regard to the sewing of the fabric edges to form the hose, the present invention is also not subject to any relevant limitations. In one embodiment, the seams can be formed as seams with double lockstitches, chain stitches, or double chain stitches, wherein it is preferred for this case if the seams are formed with a stitch density in the range of 1.5 to 6 stitches/cm and particularly 2.5 to 5 stitches per cm.

The thread material or sewing yarn used to join the overlapping edges of the fabric is also not subject to any relevant limitations as long as the material itself is sufficiently stable. However, it can be indicated as particularly suitable if the thread material or sewing yarn has a total fineness in the range from 1000 to 3000 dtex and preferably 1200 to 2500 dtex, and/or a maximum tensile force of more than 50 N and preferably in the range from 70 to 200 N.

A further aspect of the present invention relates to the use of a textile hose as described above as a calibrating hose for sealing of defective pipes, wherein the calibrating hose is used to press a composite of an outer hose and a felt layer impregnated with a synthetic resin mixture inserted into the defective pipe against the inner walls of the defective pipe. This is conveniently done by filling the textile hose with a gas, in particular air.

The outer hose in this use is suitably formed by a water-impermeable material, e.g., a plastic, but the outer hose may also be formed by a fabric. It is also possible for the outer hose to be a water-impermeable fabric hose in which a fabric is combined with a water-impermeable material.

A further aspect of the invention relates to a kit for rehabilitating a pipe, in particular a sewer pipe, comprising a textile hose A corresponding to the textile hose described above and a hose B having an outer fabric layer, which is preferably impermeable to water, and an inner layer, which comprises a felt layer and a synthetic resin mixture impregnated therein, wherein the outer diameter of the textile hose A is matched to the inner diameter of the hose B such that the textile hose A, when completely filled with a gas, abuts against the inner layer of the hose B. This means that the outer diameter of the textile hose A is slightly smaller than the inner diameter of the hose B, which results from the fact that the felt layer is pressed against the outer fabric layer when the textile hose A is filled with gas.

The outer hose in the two aspects described above is preferably made of polyurethane or contains polyurethane to form a continuous layer in which a fabric is embedded, if necessary. Alternatively or additionally, the outer hose has an areal weight in the range of 170 to 500 g/m² and preferably 200 to 300 g/m².

The fiber material from which the felt layer is formed is suitably a material commonly used in conventional pipe repair systems, as specified above for the prior art. The fibers of the fiber material can be formed from an organic material, such as a thermoplastic polymer, in particular in the form of polyester, or an inorganic material, e.g., glass. In a preferred embodiment, the fiber material of the felt layer is based on glass fibers, and particularly is a glass fiber felt. In another preferred embodiment, the fiber material is based on polyester and preferably has a weight in the range of 400 to 800 g/m², in particular 500 to 700 g/m². Regardless of the material from which the felt layer is formed, it preferably has a pore volume in the range of 85 to 97% and particularly preferably in the range of 90 to 95%.

If the curable system according to the invention has a fiber composite layer based on plastic fibers, in particular in the form of polyester fibers, the fiber composite layer can be laminated with a polyurethane layer, which is arranged on the side of the fiber composite layer opposite the outer plastic layer. Hose systems being such equipped are commercially available under the designation “Brawoliner®” by the company Brawo Systems, for example.

The synthetic resin is usually a curable material, wherein the curing can preferably be initiated by the introduction of heat, steam, or light. In order for the synthetic resin to be introduced into gaps in the felt, it is useful if the synthetic resin has a sufficiently low viscosity for the impregnation of fiber materials (wherein this viscosity can also be achieved by adding a solvent or by impregnation at an elevated temperature). Particularly suitable synthetic resins in this context are, for example, polyester resins (UP resins), vinyl ester resins (VE), and epoxy resins. Most preferably, the resin is a two-component epoxy resin having a first component formed predominantly from epoxy components including diglycidyl ethers of bisphenol A, bisphenol F or mixtures of bisphenol A and F, and oligomerization products of such bisphenols and glycerol; and a second component comprising diamines, which preferably contain at least one of aminoethylpiperazine, condensation products of polypropylene glycol and aminopropanol (1-aminopropan-2-ol and/or 1-aminopropan-3-ol), 2-methylpentane-1,5-diamine, isophorone diamines, 2,4,6-tris(dimethylaminomethyl)phenol, trimethylhexane-1,6-diamine, 3,6-diazaoctane-1,8-diamine, and m-phenylene bis(methylamine), or are formed from these compounds. Commercially available two-component epoxy resins, which can be used as synthetic resins in the context of the invention, are, for example, the resin systems commercially available from Bodus GmbH under the designations EP 50 and EP 80.

The synthetic resin may additionally contain other components and additives to control properties, including but not limited to catalysts, heat and/or light stabilizers, thixotropic agents, plasticizers, solvents, mineral, or organic fillers, blowing agents, dyes, and pigments.

A still further aspect of the present invention relates to processes for rehabilitating a pipe, in particular a sewer pipe, preferably using a kit as described above, comprising the following steps:
a) forming an inner liner S1 within a pipe, wherein the inner liner comprises a fabric layer S11 which is in contact with the inner wall of the pipe and is preferably impermeable to water, and an inner layer containing a felt hose S12 and a synthetic resin mixture,
b) inserting a textile hose S2, according to a textile hose as described above and which is coated with a release agent, preferably silicone, which does not adhere to the synthetic resin mixture, into the interior of the inner liner S1,
c) sealing the textile hose in an essentially airtight manner S2,
d) inflating the textile hose S2,
e) permanently pressing the textile hose S2 and the inner liner S1 radially against the pipe,
f) allowing the curable synthetic resin mixture to cure,
g) removing the textile hose S2 from the inside of the inner liner S1.

The fabric layer S11 can be formed as a fabric-reinforced hose, i.e., a hose that has a continuous matrix and a fabric embedded therein. Alternatively, it is possible that instead of the fabric layer, only a continuous matrix without fabric is present (i.e., as a slideway or film hose). In this case, the hose can be formed in one piece (without edges being connected). A fabric layer can either be formed as a one-piece woven or can suitably be formed with a seam, in particular in combination with a plastic web, as described above for the hose according to the invention.

For introducing the fabric S11, or a layer corresponding to this layer which is not formed from a fabric, it is irrelevant whether the layer is introduced into the pipe separately from the felt hose, and the felt hose S12 is introduced into the fabric along with the plastic mixture independently of the layer S11 in a second step, or whether the layers S11 and S12 are introduced into the pipe as a composite (with a loose connection or a connection formed solely by the uncured synthetic resin). It is particularly advantageous here if the felt layer $12 and layer S11 are attached to each other before insertion into the pipe in such a way that the felt layer forms the outer layer and the sequence of layers is reversed when the composite is inserted into the pipe by inverting it. In this case, the synthetic resin can be applied to the felt layer at the construction site and worked into the felt layer, wherein a contamination of other components by the synthetic resin can be largely avoided. The process can also be used for pipes where only a one-sided access is possible at the time of installation (open-end technology).

The pipes that are rehabilitated or sealed as part of the process described are preferably sewer or wastewater pipes.

A device with which the process according to the invention can be carried out is described, for example, in WO 2022/171622 A1, the relevant content of which is hereby incorporated by reference into the application.

In an advantageous embodiment of the process according to the invention, the textile hose S12 is subjected to heat, steam, or light in its interior during steps f) and g). If the second textile hose is sealed airtight, the curing of the synthetic resin mixture can be advantageously supported and accelerated by a heat, steam, or light source arranged in it.

In a further advantageous embodiment of the process according to the invention, the textile hose is inflated to a pressure of up to 4 bar in step e), so that the first hose is pressed firmly against the pipe, in particular the waste water pipe. This procedure enables the production of extremely tight and almost perfect pipe linings. At this stage of the process, the textile hose is already under such a pressure that no groundwater or similar can enter the lining from the outside until the synthetic resin has hardened.

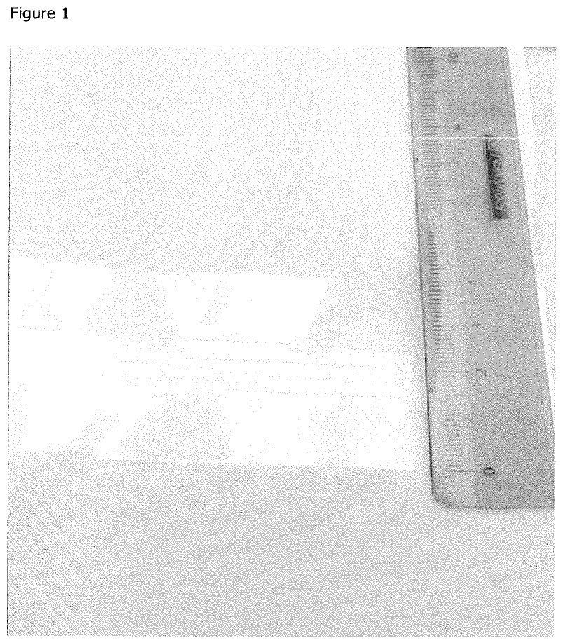

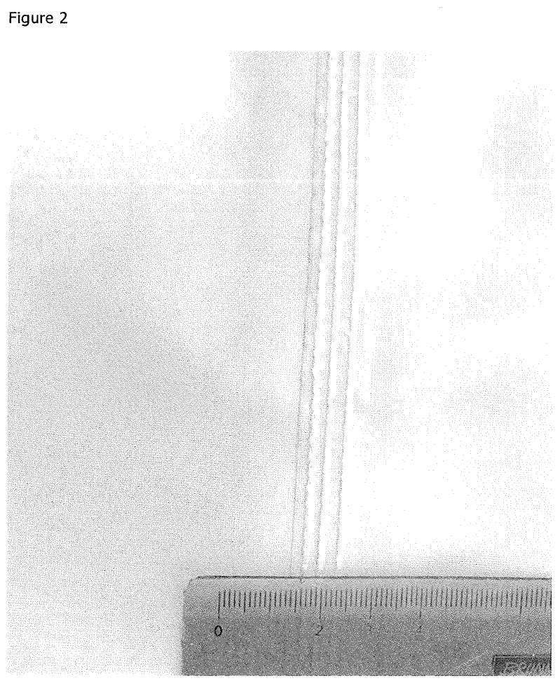

A textile hose construction according to the invention is shown in FIGS. 1 (front) and 2 (rear). The “front side” here refers to the side on which the hose can abut against a felt layer; the surface of this layer is siliconized in the hose shown. The hose has a flat width of 20 cm and is made from an airbag fabric that has been joined into a hose with an overlapping edge and three seams. A polyurethane strip about 4 cm wide is attached to the front of the hose over the seams so that the seams are positioned centrally thereto and the strip protrudes beyond the seams by about 1.5 cm in the width direction. The seams are arranged at a distance of around 3 mm from each other.

1. A textile hose made of a fabric with a maximum tensile force according to DIN 53857 of at least 2200 N/5 cm and an air permeability of less than 10 l/dm²×min, characterized in that the fabric is connected over the entire length of the hose by at least one seam via overlapping edges of the fabric and a plastic web which extends over the seam area of the hose, is attached to the outer side of the seam.

2. The textile hose according to claim 1, wherein the overlapping edges of the fabric are sewn with at least two seams which are placed at a distance in the range of 0.1 to 1 cm.

3. The textile hose according to claim 1, wherein the fabric is a polyamide or PET fabric, and is based on fibers of polyamide 6, polyamide 6.6, polyamide 4.6, or polyethylene terephthalate.

4. The textile hose according to claim 1, wherein the fabric has weft and warp threads with a fineness in the range from 200 to 700 dtex.

5. The textile hose according to claim 1, wherein the hose is modified on its outer side with an adhesion-suppressing coating.

6. The textile hose according to claim 1, wherein the plastic web is based on a polyolefin, polysilicone, or polyurethane as plastic, and/or wherein the plastic web extends over a width in the range of 0.5 to 3 cm over the seam or seams with which the edges of the hose are joined.

7. The textile hose according to claim 1, wherein the hose has a diameter in the range of 5 to 30 cm.

8. The textile hose according to claim 1, wherein the seams are executed with double lockstitches or double chain stitches.

9. The textile hose according to claim 1, wherein the seams are formed from a sewing yarn with a total fineness in the range from 1000 to 3000 dtex and/or have a maximum tensile force of more than 50 N.

10. A method of sealing defective pipes, wherein the textile hose of claim 1 is used as a calibrating hose to press a composite of an outer hose and a felt layer impregnated with a synthetic resin mixture inserted into the defective pipe against the inner walls of the defective pipe.

11. A kit for rehabilitating a pipe comprising a textile hose A according to claim 1 and a hose B having an outer fabric layer which is impermeable to water and an inner layer containing a felt layer and a synthetic resin mixture, wherein the outer diameter of the textile hose A is matched to the inner diameter of the hose B such that the textile hose A, when completely filled with a gas, abuts against the inner layer of the hose B.

12. A kit for rehabilitating a pipe according to claim 11, wherein the synthetic resin mixture is curable, and wherein the curing can be initiated by the introduction of heat, steam, or light.

13. A process for rehabilitating a pipe, in particular a sewer pipe, using a kit according to claim 11, comprising the following steps:
a) forming an inner liner (S1) within a pipe, wherein the inner liner comprises a fabric layer in contact with the inner wall of the pipe, which is preferably impermeable to water, and an inner layer containing a felt hose and a synthetic resin mixture,
b) inserting the textile hose (S2), which is coated with a release agent, which does not adhere to the synthetic resin mixture, into the interior of the inner liner (S1),
c) sealing the textile hose in an essentially airtight manner (S2),
d) inflating the textile hose (S2),
e) permanently pressing the textile hose (S2) and the inner liner (S1) radially against the pipe,
f) allowing the curable synthetic resin mixture to cure,
g) removing the textile hose (S2) from the inside of the inner liner (S1).

14. The process according to claim 13, characterized in that the textile hose (S2) is subjected to heat, steam, light, or microwaves in its interior during steps f) and g).

15. The textile hose according to claim 1, wherein the overlapping edges of the fabric are sewn with at least three seams, which are placed at a distance in the range of 0.2 to 0.6 cm from each other.

16. The textile hose according to claim 1, wherein the fabric has weft and warp threads with a fineness in the range 230 to 500 dtex, and/or an areal weight in the range from 140 to 300 g/m².

17. The textile hose according to claim 1, wherein the hose is modified on its outer side with a silicone coating.

18. The textile hose according to claim 1, wherein the plastic web is based on a polyolefin, polysilicone, or polyurethane as plastic, and/or wherein the plastic web extends over a width in the range of 1 to 2 cm over the seam or seams with which the edges of the hose are joined.

19. The textile hose according to claim 1, wherein the hose has a diameter in the range of 8 to 20 cm.

20. The textile hose according to claim 1, wherein the seams are executed with double chain stitches with a stitch density in the range of 2.5 to 5 stitches per cm and wherein the seams are formed from a sewing yarn with a total fineness in the range from 1200 to 2500 dtex, and/or have a maximum tensile force in the range from 70 to 200 N.
